(19) United States
(12) Patent Application Publication
(10) Pub. No.: US 2020/0234652 A1
(43) Pub. Date: Jul. 23, 2020

(54) PIXEL CIRCUIT AND DRIVING METHOD THEREOF, AND DISPLAY APPARATUS

(71) Applicant: Kunshan Go-Visionox Opto-Electronics Co., Ltd., Kunshan (CN)

(72) Inventors: Zhengyong ZHU, Kunshan (CN); Guangyuan SUN, Kunshan (CN); Hui ZHU, Kunshan (CN)

(21) Appl. No.: 16/841,692

(22) Filed: Apr. 7, 2020

Related U.S. Application Data
(63) Continuation of application No. PCT/CN2019/080183, filed on Mar. 28, 2019.

(30) Foreign Application Priority Data
Sep. 28, 2018 (CN) 201811137019.5

(51) Int. Cl. G09G 3/3283; G09G 3/3266

(52) U.S. Cl. CPC G09G 3/3283; G09G 2320/0233; G09G 3/3266

(57) ABSTRACT

The present disclosure relates to a pixel circuit, a driving method of a pixel circuit, and a display apparatus. The pixel circuit includes a first transistor, a second transistor, a third transistor, a fourth transistor, a fifth transistor, a sixth transistor, a seventh transistor, a first capacitor and an organic light-emitting diode. A control terminal of the fourth transistor is configured to input a first scanning signal. A first electrode of the fourth transistor is connected to a second electrode of the third transistor, a control terminal of the first transistor and a terminal of the first capacitor. Another terminal of the first capacitor is connected to a second electrode of the second transistor, a second electrode of the fifth transistor and a first electrode of the first transistor.

### CROSS-REFERENCES TO RELATED APPLICATIONS

The present application is a continuation application of the PCT application No. PCT/CN2019/080183, filed on Mar. 28, 2019 and titled “PIXEL CIRCUIT AND DRIVING METHOD THEREOF, AND DISPLAY APPARATUS”, which claims the priority of the Chinese Patent Application No. 201811137019.5, filed on Sep. 28, 2018 entitled “PIXEL CIRCUIT AND DRIVING METHOD THEREOF, AND DISPLAY APPARATUS”, and the contents of the both applications are incorporated by reference herein in their entireties.

### TECHNICAL FIELD

The present disclosure relates to the field of driving pixels of Organic Light-Emitting Diode (OLED).

### BACKGROUND

An organic light-emitting diode display is a display provided with an organic light-emitting diode (OLED) as a light-emitting device. In comparison with a thin film transistor-liquid crystal display (TFT-LCD), the OLED display has advantages of high contrast, wide viewing angle, low power consumption, small thickness, and the like. The brightness level of the OLED is determined by a current generated by driving a thin film transistor (TFT) circuit.

A driving method of a conventional active-matrix organic light emitting diode (AMOLED) includes outputting a data voltage from a data wire, and writing the data voltage into the pixel circuit directly, thereby controlling the brightness of the pixel.

### SUMMARY

The various embodiments provided in the present disclosure provide a pixel circuit, a driving method of the pixel circuit, and a display apparatus.

A pixel circuit is provided, including: a transistor T₁, a transistor T₂, a transistor T₃, a transistor T₄, a transistor T₅, a transistor T₆, a transistor T₇, a capacitor C₁, and an organic light-emitting diode OLED; a control terminal of the transistor T₄ is configured to input a first scanning signal; a first electrode of the transistor T₄ is connected to a second electrode of the transistor T₃, a control terminal of the transistor T₁ and a terminal of the capacitor C₁; another terminal of the capacitor C₁ is connected to a second electrode of the transistor T₂, a second electrode of the transistor T₅ and a first electrode of the transistor T₁; a control terminal of the transistor T₅ is configured to input a light-emitting control signal, and a first electrode of the transistor T₅ is configured to input a first voltage supply V_{DD}; a second electrode of the transistor T₄ is configured to input a reference voltage V_{ref}, and the second electrode of the transistor T₄ is connected to a second electrode of the transistor T₇; a control terminal of the transistor T₂ is configured to input a second scanning signal, and a first electrode of the transistor T₂ is configured to input a data voltage V_{data}; a control terminal of the transistor T₃ is configured to input the second scanning signal, and a first electrode of the transistor T₃ is connected to a second electrode of the transistor T₁ and a first electrode of the transistor T₆; a control terminal of the transistor T₆ is configured to input the light-emitting control signal, and a second electrode of the transistor T₆ is connected to a first electrode of the transistor T₇; a control terminal of the transistor T₇ is configured to input the first scanning signal, and the first electrode of the transistor T₇ is connected to an input terminal of the organic light-emitting diode OLED; an output terminal of the organic light-emitting diode OLED is configured to input a second voltage supply V_{SS}.

Optionally, the transistor T₁, the transistor T₂, the transistor T₃, the transistor T₄, the transistor T₅, the transistor T₆ and the transistor T₇ are p-type transistors.

Optionally, the reference voltage V_{ref} is lower than the second voltage supply V_{SS}.

A driving method of the pixel circuit above is provided. The driving method includes: in an initializing phase, setting the first scanning signal to be a low level signal, and setting the second scanning signal to be a high level signal; initializing, by the reference voltage V_{ref}, an anode of the organic light-emitting diode OLED and the control terminal of the transistor T₁; in a storing phase, setting the first scanning signal and the light-emitting control signal to be high level signals, and setting the second scanning signal to be a low level signal; writing, by the data voltage V_{data}, a compensating voltage into the capacitor C₁; in a light emitting phase, setting the first scanning signal and the second scanning signal to be high level signals, and setting the light-emitting control signal to be a low level signal; applying the first voltage supply V_{DD} to the organic light-emitting diode OLED, so that the organic light-emitting diode OLED emits light.

Optionally, in the initializing phase, the light-emitting control signal is a high level signal.

Optionally, in the initializing phase, the light-emitting control signal is a low level signal.

Optionally, the initializing phase comprises a first initializing phase and a second initializing phase; in the first initializing phase, setting the first scanning signal and the light-emitting control signal to be low level signals, and setting the second scanning signal to be a high level signal; controlling, by the light-emitting control signal, the transistor T₅ and the transistor T₆ to turn on; and controlling, by the first scanning signal, the transistor T₇ to turn on; in the second initializing phase, setting the first scanning signal to be a low level signal, and setting the second scanning signal and the light-emitting control signal to be high level signals; controlling, by the light-emitting control signal, the transistor T₅ and the transistor T₆ to be off; and controlling, by the first scanning signal, the transistor T₇ to turn on.

Optionally, in the storing phase, the driving method further comprising: controlling, by the light-emitting control signal, the transistor T₅ to be off; controlling, by the second scanning signal, the transistor T₂ to turn on; and a potential of the first electrode of the transistor T₁ being equal to the data voltage V_{data}; a potential of the control terminal of the transistor T₁ being equal to V_{data}−|Vₜₕ|.

Optionally, in the light emitting phase, the driving method further comprising: controlling, by the light-emitting control signal, the transistor T₅ to turn on; controlling, by the first scanning signal, the transistor T₄ to be off; and controlling, by the second scanning signal, the transistor T₃ to be off; the potential of the first electrode of the transistor T₁ being equal to the first voltage supply V_{DD}; the potential of the control terminal of the transistor T₁ being equal to V_{data}−|Vₜₕ|+η(V_{DD}−V_{data}); wherein η is a voltage division ratio coefficient determined by a capacitance of the capacitor C₁ and a capacitance of capacitor C₂, and a sum of the capacitance of the capacitor C₂ and the capacitance of the capacitor C₁ is an overall capacitance at the control terminal of the transistor T₁.

A display apparatus is provided, including the pixel circuit of any one of the above-mentioned embodiments.

In view of the above-mentioned pixel circuit, the driving method of the pixel circuit, and the display apparatus, the pixel circuit includes the transistor T₁, the transistor T₂, the transistor T₃, the transistor T₄, the transistor T₅, the transistor T₆, the transistor T₇, the capacitor C₁, and the organic light-emitting diode OLED. In the initializing phase, the reference voltage V_{ref} is applied to the anode of the organic light-emitting diode OLED through the transistor T₇, thereby realizing the initialization of the anode of the organic light-emitting diode OLED. The reference voltage V_{ref} is applied to the control terminal of the transistor T₁ through the transistor T₄, thereby initializing the control terminal of the transistor T₁. In the light emitting phase, the light-emitting control signal controls the transistor T₅ to turn on, the potential of the first electrode of the transistor T₁ is changed from the data voltage V_{data} to the first voltage supply V_{DD}. The transistor T₃ and the transistor T₄ are off, the charge of the capacitor C₁ remains constant, and the potential of the control terminal of the transistor T₁ is changed from V_{data}−|Vₜₕ| to V_{data}−|Vₜₕ|+η(V_{DD}−V_{data}), therefore the coefficient in the formula for the current flowing through the organic light-emitting diode OLED is (η−1), wherein η is approximate to 1. Therefore there can be a greater difference between the values of the data voltages V_{data} respectively corresponding to adjacent gray scales, thereby solving the technical problem that the gray scales cannot be easily spread.

### BRIEF DESCRIPTION OF THE DRAWINGS

FIG. 1 is a circuit diagram of a pixel circuit of an embodiment of the present disclosure;

FIG. 2 is a circuit diagram of a pixel circuit with p-type thin film transistors, of an embodiment of the present disclosure;

FIG. 3 is a timing diagram of a driving method of an embodiment of the present disclosure;

FIG. 4 is a timing diagram of a driving method of an embodiment of the present disclosure;

FIG. 5 is a timing diagram of a driving method of an embodiment of the present disclosure;

FIG. 6 is a structural diagram of a display apparatus of an embodiment of the present disclosure.

### DETAILED DESCRIPTION OF THE INVENTION

In order to make the objectives, features, and advantages of the present disclosure more apparent and comprehensible, the specified embodiments of the present disclosure will be illustrated in detail in combination with the drawings. The specified details illustrated below facilitate the understanding of the present disclosure. However, the present disclosure can be implemented in many manners other than these described herein. Those skilled in the art can make similar improvements without departing from the contents of the present disclosure. Therefore, the present disclosure is not limited to the specific embodiments disclosed below.

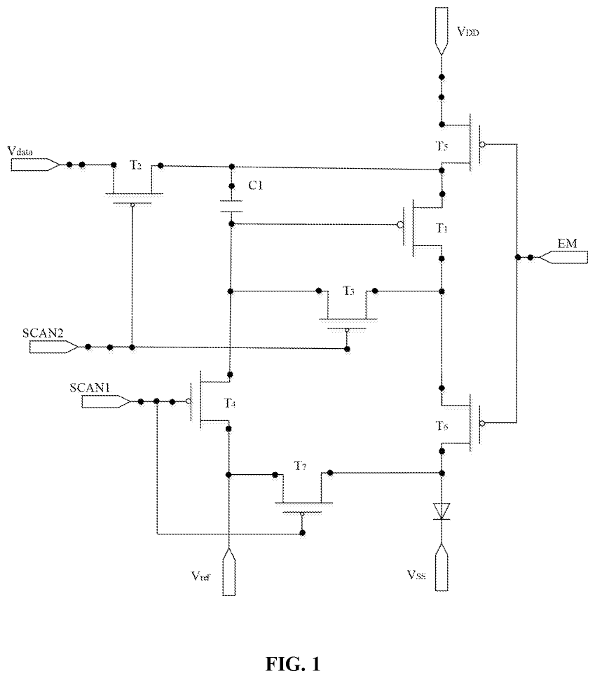

In an embodiment, referring to FIG. 1, the present disclosure provides a pixel circuit. The pixel circuit includes a transistor T₁, a transistor T₂, a transistor T₃, a transistor T₄, a transistor T₅, a transistor T₆, a transistor T₇, a capacitor C₁, and an organic light-emitting diode (OLED). Each transistor from the transistor T₁ to the transistor T₇ has a control terminal, a first electrode, and a second electrode.

Specifically, a control terminal of the transistor T₄ is connected to a first scanning signal terminal, and is configured to input a first scanning signal SCAN1 transmitted through a first scanning signal wire. A first electrode of the transistor T₄ is connected to a second electrode of the transistor T₃, a control terminal of the transistor T₁, and a terminal of the capacitor C₁. Another terminal of the capacitor C₁ is connected to a second electrode of the transistor T₂, a second electrode of the transistor T₅, and a first electrode of the transistor T₁.

The control terminal of the transistor T₅is connected to a light emitting control terminal, and is configured to input a light-emitting control signal EM transmitted through a light emitting control wire. The first electrode of the transistor T₅ is connected to a first power supply, and is configured to input a first voltage supply V_{DD}.

The second electrode of the transistor T₄ is configured to input a reference voltage V_{ref}, and is connected to the second electrode of the transistor T₇.

The control terminal of the transistor T₂ is configured to input a second scanning signal SCAN2. The first electrode of the transistor T₂ is configured to input a data voltage V_{data}.

The control terminal of the transistor T₃ is connected to a second scanning signal terminal, and is configured to input a second scanning signal SCAN2 transmitted through a second scanning signal wire. The first electrode of the transistor T₃ is connected to the second electrode of the transistor T₁ and the first electrode of the transistor T₆.

The control terminal of the transistor T₆ is connected to the light emitting control terminal, and is configured to input the light-emitting control signal EM transmitted through the light emitting control wire. The second electrode of the transistor T₆ is connected to the first electrode of the transistor T₇.

The control terminal of the transistor T₇ is connected to the first scanning signal terminal, and is configured to input the first scanning signal SCAN1 transmitted through the first scanning signal wire. The first electrode of the transistor T₇ is connected to the input terminal of the organic light-emitting diode OLED.

The output terminal of the organic light-emitting diode OLED is configured to input a second voltage supply V_{SS}.

The transistor T₂, transistor T₃, transistor T₄, transistor T₅, transistor T₆, and transistor T₇ are switching transistors in the pixel circuit. The transistor T₁ is a driving transistor in the pixel circuit. The capacitor C₁ is an energy storage capacitor, which is connected between the control terminal of the transistor T₁ and the first electrode of the transistor T₁.

In this embodiment, the first scanning signal SCAN1 controls the transistor T₄ and the transistor T₇ to turn off or to turn on. The second scanning signal SCAN2 controls the transistor T₂ and transistor T₃ to turn off or to turn on. The light-emitting control signal EM controls the transistor T₅ to turn off or to turn on. The light-emitting control signal EM controls the transistor T₆ to turn off or turn on. When the transistor T₄ turns on, the reference voltage V_{ref} initializes the control terminal of the transistor T₁ through the transistor T₄. When the transistor T₇ is turned on, the reference voltage V_{ref} initializes the anode of the light-emitting diode OLED through the transistor T₇. When the transistor T₅ turns on, the electrode plate of the capacitor C₁, which is connected to the second electrode of the transistor T₅, is initialized. When the transistor T₂ and the transistor T₃ turn on, the data voltage V_{data} is applied to the gate of the driving transistor T₁ through the transistor T₂, the transistor T₁, and the transistor T₃. When the transistor T₅ and the transistor T₆ turn on, the first voltage supply V_{DD} is applied to the organic light-emitting diode OLED through the transistor T₅, the transistor T₁, and the transistor T₆, so that the organic light-emitting diode OLED emits light.

Optionally, the transistor T₁, the transistor T₂, the transistor T₃, the transistor T₄, the transistor T₅, the transistor T₆, and the transistor T₇ can be any one of a low-temperature polysilicon thin film transistor, an oxide semiconductor thin film transistor, and an amorphous silicon thin film transistor. The transistor T₁, the transistor T₂, the transistor T₃, the transistor T₄, the transistor T₅, the transistor T₆, and the transistor T₇ can be p-type transistors, or n-type transistors. When the transistor in the pixel circuit is a p-type transistor, a low level signal is input to the control terminal of the transistor which will turn on. When the transistor in the pixel circuit is an n-type transistor, a high level signal is input to the control terminal of the transistor which will turn on.

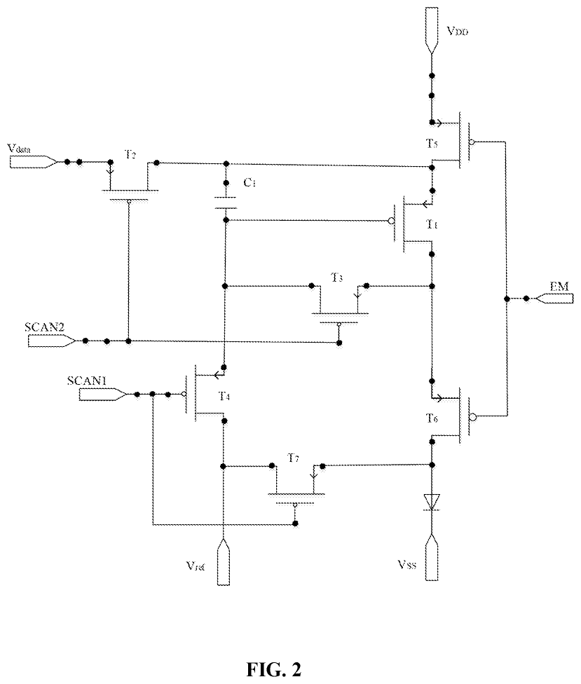

Referring to FIG. 2, in an embodiment of the pixel circuit provided by the present disclosure, the transistor T₁, transistor T₂, transistor T₃, transistor T₄, transistor T₅, transistor T₆, and transistor T₇ are p-type transistors. The control terminals can be gates of the transistor T₁ to the transistor T₇. The first electrodes can be the sources of the transistor T₁ to the transistor T₇. The second electrodes can be the drains of the transistor T₁ to the transistor T₇.

Optionally, the reference voltage V_{ref} is lower than the second voltage supply V_{SS}. In a light emitting phase, the first voltage supply V_{DD} is applied to the organic light-emitting diode OLED through the transistor T₅, the transistor T₁, and the transistor T₆, so that the organic light-emitting diode OLED emits light. The forward current flowing through the organic light emitting diode OLED will cause the accumulation of holes and the movement of indium ions in indium tin oxide, accelerating the aging of the organic light emitting diode OLED. In an initializing phase, by means of setting the reference voltage V_{ref} to be lower than the second voltage supply V_{SS} , the organic light-emitting diode OLED is biased reversely, thereby compensating the aging caused in the light emitting phase, and prolonging the service life of the organic light-emitting diode OLED.

Optionally, the present disclosure provides a driving method of a pixel circuit based on any one of the above-mentioned embodiments. The driving method sequentially includes the following steps.

In an initializing phase t1, the first scanning signal SCAN1 is a low level signal, and the second scanning signal SCAN2 is a high level signal. The reference voltage V_{ref} is configured to initialize the anode of the organic light-emitting diode OLED and the control terminal of the transistor T₁.

In a storing phase t2, the first scanning signal SCAN1 and the light-emitting control signal EM are high level signals, and the second scanning signal SCAN2 is a low level signal. The data voltage V_{data} is configured to write a compensating voltage into the capacitor C₁.

In a light emitting phase t3, the first scanning signal SCAN1 and the second scanning signal SCAN2 are both high level signals, and the light-emitting control signal EM is the low level signal. The first voltage supply V_{DD} is configured to be applied to the organic light-emitting diode OLED, so that the organic light-emitting diode OLED emits light.

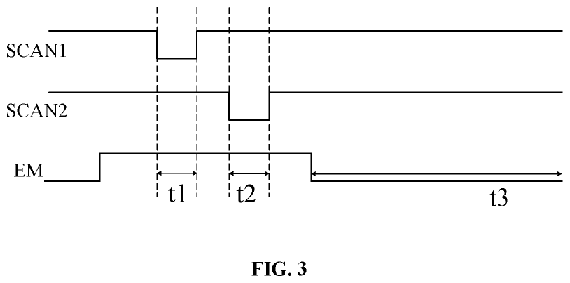

Referring to FIG. 3, FIG. 3 is a timing graph of signals corresponding to the driving method, wherein the timing graph of signals includes the initializing phase t1, the storing phase t2, and the light emitting phase t3. The working process is specified as follows.

In the initializing phase t1, the first scanning signal SCAN1 is the low level signal, and the transistor T₁, the transistor T₄, and the transistor T₇ turn on. The reference voltage V_{ref} initializes the anode of the organic light-emitting diode OLED and the control terminal of the transistor T₁. The potential of the second electrode plate of the capacitor C₁, which is connected to the control terminal of the transistor T₁, is equal to the reference voltage V_{ref}. The second scanning signal SCAN2 is the high level signal, and the transistor T₂ and the transistor T₃ are off. When the light-emitting control signal EM is a high level signal, the transistor T₅ and the transistor T₆ are off, and no driving current flows through the organic light-emitting diode OLED, thus the organic light-emitting diode OLED does not emit light. When the light-emitting control signal EM is a low level, the transistor T₅ and the transistor T₆ turn on. Since the transistor T₇ turns on, a current path is formed, and the current path is from a power supply terminal providing the first voltage supply V_{DD}, via the transistor T₅, the transistor T₁, the transistor T₆, and the transistor T₇, to a power supply terminal providing the reference voltage V_{ref}. Moreover, no driving current flows through the organic light-emitting diode OLED, so the organic light-emitting diode OLED does not emit light.

In the storing phase t2, the first scanning signal SCAN1 and the light-emitting control signal EM are both high level signals, and the transistor T₄, the transistor T₅, the transistor T₆, and the transistor T₇ are off. The second scanning signal SCAN2 is the low level signal, and the transistor T₂ and the transistor T₃ turn on. The potential of the first electrode of the transistor T₁ is equal to the data voltage V_{data}. The potential of the control terminal of the transistor T₁ is equal to V_{data}−|Vₜₕ|, wherein Vₜₕ is a threshold voltage of the transistor T₁. Specifically, the light-emitting control signal EM controls the transistor T₅ to be off, and the second scanning signal SCAN2 controls the transistor T₂ to turn on. The potential of the first electrode of the transistor T₁ is equal to the data voltage V_{data}. The potential of the control terminal of the transistor T₁ is equal to V_{data}−|Vₜₕ|. The first electrode of the transistor T₁ is connected to the first electrode plate of the capacitor C₁. The control terminal of the transistor T₁ is connected to the second electrode plate of the capacitor C₁. The potential of the first electrode plate of the capacitor C₁ is equal to the data voltage V_{data}. The potential of the second electrode plate of the capacitor C₁ is equal to V_{data}−|Vₜₕ|, thereby writing the compensating voltage |Vₜₕ| into the capacitor C₁.

In the light emitting phase t3, the first scanning signal SCAN1 and the second scanning signal SCAN2 are both high level signals, and the transistor T₄, the transistor T₇, the transistor T₂ and the transistor T₃ are off. The light-emitting control signal EM is the low level signal, and the transistor T₅ and the transistor T₆ turn on. The first voltage supply V_{DD} is applied to the organic light-emitting diode OLED through the transistor T₅, the driving transistor T₁, and the transistor T₆, so that the organic light-emitting diode OLED emits light.

Specifically, the first electrode plate of the capacitor C₁ is connected to the first electrode of the transistor T₁, and the second electrode plate of the capacitor C₁ is connected to the control terminal of the transistor T₁. The light-emitting control signal EM controls the transistor T₅ to turn on. The potential of the first electrode plate of the capacitor C₁ is equal to the first voltage supply V_{DD}. In the storing phase t2, when the potential of the first electrode plate of the capacitor C₁ is equal to V_{data}, the potential variation value of the first electrode plate of the capacitor C₁ is V_{DD}−V_{data}. Among overall capacitance at a node of the control terminal of the transistor T₁, other capacitance excluding the capacitance of the capacitor C₁ is represented by capacitance of a capacitor C₂. The voltage division effect of the capacitor C₂ further affects the potential of the second electrode plate of the capacitor C₁, and the potential of the second electrode plate of the capacitor C₁ is equal to V_{data}−|Vₜₕ|+η(V_{DD}−V_{data}), wherein η is a voltage division ratio coefficient determined by the capacitance of the capacitor C₁ and the capacitor C₂. The sum of the capacitor C₂ and the capacitance of the capacitor C₁ is the overall capacitance at the node between the control terminal of the transistor T₁ and the capacitor C₁.

In this embodiment, the potential of the first electrode of the transistor T₁ is changed from the data voltage V_{data} to the first voltage supply V_{DD}. The transistor T₃ and the transistor T₄ are off, and the charge of the capacitor C₁ remains constant, and the potential of the control terminal of the transistor T₁ is changed from V_{data}−|Vₜₕ| to V_{data}−|Vₜₕ|+η(V_{DD}−V_{data}), therefore the coefficient in the formula for the current flowing through the organic light-emitting diode OLED is (η−1), wherein η is approximate to 1. Therefore there can be a greater difference between the values of the data voltages V_{data} respectively corresponding to adjacent gray scales. The data voltages corresponding to the adjacent gray scales can be precisely controlled, thereby solving the technical problem that the gray scales cannot be easily spread.

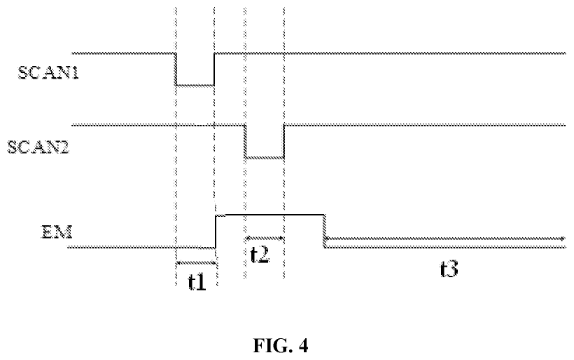

Optionally, referring to FIG. 4, FIG. 4 is a timing graph of signals corresponding to the driving method, wherein the light-emitting control signal EM is the low level. The timing graph of signals includes the initializing phase t1, the storing phase t2, and the light emitting phase t3. The working process of the initializing phase t1 is as follows.

The first scanning signal SCAN1 is the low level signal, and the transistor T₁, the transistor T₄, and the transistor T₇ turn on. The reference voltage V_{ref} initializes the anode of the organic light-emitting diode OLED and the control terminal of the transistor T₁. The potential of the second electrode plate of the capacitor C₁, which is connected to the control terminal of the transistor T₁, is equal to the reference voltage V_{ref}. The second scanning signal SCAN2 is the high level signal, and the transistor T₂ and the transistor T₃ are off. The light-emitting control signal EM is the low level.

On the one hand, the transistor T₅ and the transistor T₆ turn on. Since the transistor T₇, the transistor T₅, and the transistor T₆ turn on, a current path is formed, which is from the power supply terminal providing the first voltage supply V_{DD}, via the transistor T₅, the transistor T₁, the transistor T₆, and the transistor T₇, to the power supply terminal providing the reference voltage V_{ref}. Moreover, no driving current flows through the organic light-emitting diode OLED, therefore the organic light-emitting diode OLED does not emit light.

On the other hand, the light-emitting control signal EM controls the transistor T₅ to turn on, and the first voltage supply V_{DD} initializes the first electrode plate of the capacitor C₁, which is connected to the first electrode of the transistor T₁. Therefore, the potential of the first electrode plate of the capacitor C₁, which is connected to the second electrode of the transistor T₅, is equal to the first voltage supply V_{DD}, and the potential of the second electrode plate of the capacitor C₁, which is connected to the control terminal of the transistor T₁, is equal to the reference voltage V_{ref}. Thus it is realized that the capacitor C₁ has the same state in time of each image frame after the capacitor C₁ is initialized, thereby ensuring the accuracy of the light emitting control.

The working processes of the storing phase t2 and the light emitting phase t3 are the same as the working process corresponding to the timing graph of signals shown in FIG. 3, which will not be described herein repeatedly.

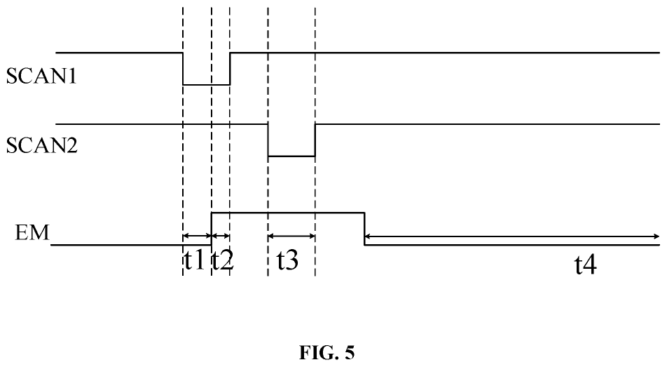

Optionally, the initializing phase includes a first initializing phase and a second initializing phase. Referring to FIG. 5, FIG. 5 is a timing graph of signals corresponding to the driving method, wherein the timing graph of signals includes the first initializing phase t1, the second initializing phase t2, the storing phase t3, and the light emitting phase t4. The working processes of the first initializing phase t1 and the second initializing phase t2 are as follows.

In the first initializing phase t1, the first scanning signal SCAN1 and the light-emitting control signal EM are both the low level signals, and the second scanning signal SCAN2 is the high level signal. The first scanning signal SCAN1 controls the transistor T₇ to turn on, and the light-emitting control signal controls the transistor T₅ and the transistor T₆ to turn on. Since the transistor T₇, the transistor T₅, and the transistor T₆ turn on, a current path is formed, which is from the power supply terminal providing the first voltage supply V_{DD}, via the transistor T₅, the transistor T₁, the transistor T₆, and the transistor T₇, to the power supply terminal providing the reference voltage V_{ref}. Moreover, the light-emitting control signal EM controls the transistor T₅ to turn on, and the first voltage supply V_{DD} initializes the first electrode plate of the capacitor C₁, which is connected to the first electrode of the transistor T₁. Therefore, the potential of the first electrode plate of the capacitor C₁, which is connected to the second electrode of the transistor T₅, is equal to the first voltage supply V_{DD}, and the potential of the second electrode plate of the capacitor C₁, which is connected to the control terminal of the transistor T₁, is equal to the reference voltage V_{ref}. Thus it is realized that the capacitor C₁ has the same state in time of each image frame after the capacitor C₁ is initialized, thereby ensuring the accuracy of the light emitting control.

In the second initializing phase, the first scanning signal SCAN1 is the low level signal, and the second scanning signal SCAN2 and the light-emitting control signal EM are both the high level signals. The light-emitting control signal controls the transistor T₅ and the transistor T₆ to be off. Specifically, in the second initializing phase, the light-emitting control signal EM is changed from the low level signal to the high level signal, thus reducing the time of the current flowing through the transistor T₅, the transistor T₁, the transistor T₆,and the transistor T₇, reducing the consumption, and slowing down the aging of the driving transistor T₁ as well, thereby prolonging the service life of the driving transistor T₁.

The working processes of the storing phase t3 and the light emitting phase t4 are the same as the working processes corresponding to the timing graph of signals shown in FIG. 3, which will not be described herein repeatedly.

Optionally, referring to FIGS. 2 to 5, FIG. 5 is the timing graph of signals corresponding to the driving method, wherein the timing graph of signals includes the first initializing phase t1, the second initializing phase t2, the storing phase t3, and the light emitting phase t4. The working processes are specified as follows.

In the first initializing phase t1, the first scanning signal SCAN1 is the low level signal, and the transistor T₄ turns on, and the reference voltage V_{ref} initializes the gate of the transistor T₁. The transistor T₇ turns on, and the reference voltage V_{ref} initializes the anode of the light-emitting diode OLED. The light-emitting control signal EM is the low level signal, and the transistor T₅ and the transistor T₆ turn on, and the first voltage supply V_{DD} initializes the first electrode plate of the capacitor C₁, which is connected to the source of the transistor T₁. Therefore, the potential of the first electrode plate of the capacitor C₁, which is connected to the drain of the transistor T₅, is equal to the first voltage supply V_{DD}, and the potential of the second electrode plate of the capacitor C₁, which is connected to the control terminal of the transistor T₁, is equal to the reference voltage V_{ref}. Thus it is realized that the capacitor C₁ has the same state in time of each image frame after the capacitor C₁ is initialized, thereby ensuring the accuracy of the light emitting control.

Since the transistor T₇, the transistor T₅, and the transistor T₆ turn on, a current path is formed, which is from the power supply terminal providing the first voltage supply V_{DD}, via the transistor T₅, the transistor T₁, the transistor T₆, and the transistor T₇, to the power supply terminal providing the reference voltage V_{ref}, thereby ensuring the light-emitting diode OLED not to emit light.

In the second initializing phase, the first scanning signal SCAN1 is the low level signal, and the second scanning signal SCAN2 and the light-emitting control signal EM are both the high level signals. The light-emitting control signal controls the transistor T₅ and the transistor T₆ to be off. Specifically, in the second initializing phase, the light-emitting control signal EM is changed from the low level signal to the high level signal, thus reducing the time of the current flowing through the transistor T₅, the transistor T₁, the transistor T₆, and the transistor T₇, reducing the consumption, and slowing down the aging of the driving transistor T₁, thereby prolonging the service life of the driving transistor T₁.

In the storing phase t2, the first scanning signal SCAN1 and the light-emitting control signal EM are both the high level signals, and the transistor T₄, the transistor T₅, the transistor T₆, and the transistor T₇ turn off. The second scanning signal SCAN2 is the low level signal, and the transistor T₂ and the transistor T₃ turn on. The data voltage V_{data} is applied to the source of the transistor T₁ through the transistor T₂, till the transistor T₁ is in a critical state. The potential of the source of the transistor T₁ is equal to the data voltage V_{data}, and the potential of the gate of the transistor T₁ is equal to V_{data}−|Vₜₕ|. Since the gate of the transistor T₁ and the source of the transistor T₁ are respectively connected to the two electrode plates of the capacitor C₁, the compensating voltage |Vₜₕ| is written into the capacitor C₁.

At this time, the gate voltage of the transistor T₂ is V_{data}−|Vₜₕ|, wherein Vₜₕ is the threshold voltage of the transistor T₁, and the value of the threshold voltage is negative, thus the gate voltage of the transistor T₁ is V_{data}+Vₜₕ.

In the light emitting phase t3, the first scanning signal SCAN1 and the second scanning signal SCAN2 are both the high level signals, and the transistor T₄, the transistor T₇ are turned off, the transistor T₂ and the transistor T₃ turn off. The light-emitting control signal EM is the low level signal, and the transistor T₅ and the transistor T₆ turn on. The first voltage supply V_{DD} is applied to the organic light-emitting diode OLED through the transistor T₅, the driving transistor T₁, and the transistor T₆, so that the organic light-emitting diode OLED emits light.

The first electrode plate of the capacitor C₁ is connected to the source of the transistor T₁, and the second electrode plate of the capacitor C₁ is connected to the gate of the transistor T₁, thus the potential of the first electrode plate of the capacitor C₁ is equal to the potential of the source of the transistor T₁, and the potential of the second electrode plate of the capacitor C₁ is equal to the potential of the gate of the transistor T₁. The light-emitting control signal EM controls the transistor T₅ to turn on, and the potential of the source of the transistor T₁ is equal to the first voltage supply V_{DD}, and the potential of the first electrode plate of the capacitor C₁ is equal to the first voltage supply V_{DD}.

The transistor T₃ is off, therefore the charge of the capacitor C₁ remains constant, and the voltage difference between the two electrode plates of the capacitor C₁ also remains constant, that is, the potential of the first electrode plate of the capacitor C₁ varies along with the potential variation of the second electrode plate of the capacitor C₁.

In the storing phase t2, the potential of the first electrode plate of the capacitor C₁ is equal to V_{data}.

Within the time period from the storing phase t2 to the light emitting phase t3, the potential variation value of the first electrode plate of the capacitor C₁ is V_{DD}−V_{data}.

Among overall capacitance at a node of the gate of the transistor T₁, other capacitance excluding the capacitance of the capacitor C₁ is represented by capacitance of a capacitor C₂. Since the voltage division effect of the capacitor C₂ further affects the potential of the second electrode plate of the capacitor C₁, the potential of the second electrode plate of the capacitor ₁ is equal to V_{data}+Vₜₕ+η(V_{DD}−V_{data}).

Wherein η=c₁/(c₁+c₂), that is, η is a voltage division ratio coefficient determined by the capacitance c₁ of the capacitor C₁ and the capacitance c₂ of the capacitor C₂. The sum of the capacitance c₂ of the capacitor C₂ and the capacitance c₁ of the capacitor C₁ is the overall capacitance at the node between the control terminal of the transistor T₁ and the capacitor C₁.

The second electrode plate of the capacitor C₁ is connected to the gate of the transistor T₁, thus the potential of the gate of the transistor T₁ is equal to V_{data}−|Vₜₕ|+η(V_{DD}−V_{data}).

The gate-to-source voltage drop of the transistor T₁ is:

V_{gs}=V_{g}−Vₛ;

V_{gs}=V_{data}+Vₜₕ+η(V_{DD}−V_{data})−V_{DD};

V_{gs}=(η−1)×(V_{DD}−V_{data})+Vₜₕ.

The driving current flowing through the transistor T₁ is:

I=K×(V_{gs}−Vₜₕ)²=K×(η−1)²×(V_{DD}−V_{data})²,

wherein, K=½×μ×Cₒₓ×W/L; μ is the electron mobility of the thin-film transistor; Cₒₓ is the gate oxide capacitance per unit area of the thin-film transistor; W is the channel width of the thin-film transistor; and L is the channel length of the thin-film transistor.

Therefore, the driving current flowing through the first transistor T₁ is:

I=½×μ×Cₒₓ×W/L×(η−1)²×(V_{DD}−V_{data})².

In view of the above-mentioned equation, a coefficient (η−1)² is introduced in the equation for the current flowing through the organic light-emitting diode OLED, wherein η is approximate to 1. Therefore, there can be a greater difference between the data voltages corresponding to adjacent gray scales, thereby solving the technical problem that the gray scales cannot be easily spread. Moreover, the value of the driving current flowing through the transistor T₁ is independent of the value of the threshold voltage Vₜₕ of the transistor T₁, thereby realizing the compensation for the threshold voltage, and further making the brightness of the organic light-emitting diode OLED stable.

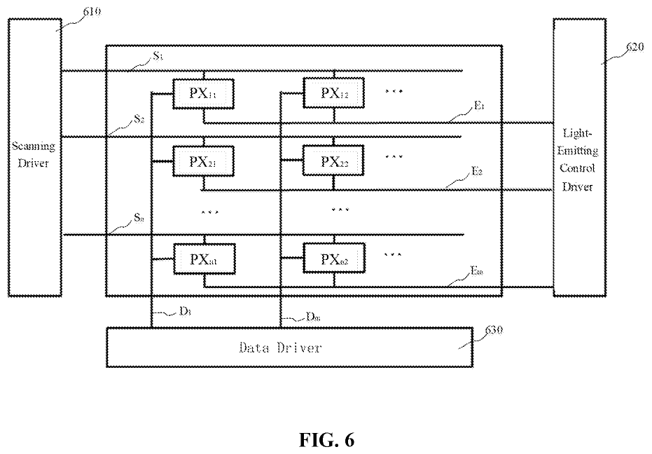

Optionally, the present disclosure provides a display apparatus. Referring to FIG. 6, the display apparatus includes: a plurality of pixels configured to display an image, each pixel including the pixel circuit of any one of the above-mentioned embodiments; a scanning driver 610 sequentially applying scanning signals to each pixel; a light emitting control driver 620 applying light-emitting control signals to each pixel; and a data driver 630 apply data voltages to each pixel.

The pixel receives the data voltage in response to the scanning signal, and the pixel emits light having a predetermined brightness corresponding to the data voltage, to display the image. The time period of light emitting of the pixel is controlled by the light-emitting control signal. The light emitting control driver is initialized in response to the initialization control signal, and generates the light-emitting control signal.

Indicated by making reference to FIG. 6, the scanning driver 610 is connected to a plurality of pixels from PX₁₁ to PXₙₘ arranged in a matrix by the scanning signal wires from S₁ to Sₙ. The pixels from PX₁₁ to PXₙₘ are connected to the light-emitting control signal wires from E₁ to Eₘ, and are also connected to the light emitting control driver 620 by the light-emitting control signal wires from E₁ to Eₘ. The pixels from PX₁₁ to PXₙₘ are also connected to the data signal wires from D₁ to Dₘ, and are connected to the data driver 630 through the data signal wires from D₁ to Dₘ. The light-emitting control signal wires from E₁ to Eₘ are substantially parallel to the scanning signal wires from S₁ to Sₙ. The light-emitting control signal wires from E₁ to Eₘ are substantially perpendicular to the data signal wires from D₁ to Dₘ.

All technical features in the embodiments can be arbitrarily combined. For purpose of simplifying the description, not all arbitrary combinations of the technical features in the embodiments illustrated above are described. However, as long as such combinations of the technical features are not contradictory, they should be considered to be within the scope of the specification of the disclosure.

The above embodiments are merely illustrations of several implementations of the disclosure, and the description thereof is more specific and detailed, but should not be deemed as limitations to the scope of the present disclosure. It should be noted that, for those skilled in the art, various deformations and improvements can be made without departing from the concepts of the present disclosure. All these deformations and improvements are within the protection scope of the present disclosure. Therefore, the protection scope of the present disclosure is defined by the appended claims.

1. A pixel circuit comprising: a first transistor, a second transistor, a third transistor, a fourth transistor, a fifth transistor, a sixth transistor, a seventh transistor, a first capacitor, and an organic light-emitting diode;
wherein:
a control terminal of the fourth transistor is configured to input a first scanning signal; a first electrode of the fourth transistor is connected to a second electrode of the third transistor, a control terminal of the first transistor and a terminal of the first capacitor; another terminal of the first capacitor is connected to a second electrode of the second transistor, a second electrode of the fifth transistor and a first electrode of the first transistor;
a control terminal of the fifth transistor is configured to input a light-emitting control signal, and a first electrode of the fifth transistor is configured to input a first voltage supply;
a second electrode of the fourth transistor is configured to input a reference voltage, and the second electrode of the fourth transistor is connected to a second electrode of the seventh transistor;
a control terminal of the second transistor is configured to input a second scanning signal, and a first electrode of the second transistor is configured to input a data voltage;
a control terminal of the third transistor is configured to input the second scanning signal, and a first electrode of the third transistor is connected to a second electrode of the first transistor and a first electrode of the sixth transistor;
a control terminal of the sixth transistor is configured to input the light-emitting control signal, and a second electrode of the sixth transistor is connected to a first electrode of the seventh transistor;
a control terminal of the seventh transistor is configured to input the first scanning signal, and the first electrode of the seventh transistor is connected to an input terminal of the organic light-emitting diode;
an output terminal of the organic light-emitting diode is configured to input a second voltage supply.

2. The pixel circuit of claim 1, wherein the first transistor, the second transistor, the third transistor, the fourth transistor, the fifth transistor, the sixth transistor and the seventh transistor are p-type transistors.

3. The pixel circuit of claim 2, wherein the reference voltage is lower than the second voltage supply.

4. A display apparatus, comprising the pixel circuit of claim 1.

5. A driving method of the pixel circuit of claim 1, comprising:
in an initializing phase, setting the first scanning signal to be a low level signal, and setting the second scanning signal to be a high level signal; initializing an anode of the organic light-emitting diode and the control terminal of the first transistor by the reference voltage;
in a storing phase, setting the first scanning signal and the light-emitting control signal to be high level signals, and setting the second scanning signal to be a low level signal; writing a compensating voltage into the first capacitor by the data voltage;
in a light emitting phase, setting the first scanning signal and the second scanning signal to be high level signals, and setting the light-emitting control signal to be a low level signal; applying the first voltage supply to the organic light-emitting diode, to make the organic light-emitting diode emit light.

6. The driving method of claim 5, wherein at the initializing phase, the light-emitting control signal is a high level signal.

7. The driving method of claim 5, wherein at the initializing phase, the light-emitting control signal is a low level signal.

8. The driving method of claim 5, wherein the initializing phase comprises a first initializing phase and a second initializing phase;
in the first initializing phase, setting the first scanning signal and the light-emitting control signal to be low level signals, and setting the second scanning signal to be a high level signal; controlling the fifth transistor and the sixth transistor to turn on by the light-emitting control signal; and controlling the seventh transistor to turn on by the first scanning signal;
in the second initializing phase, setting the first scanning signal to be a low level signal, and setting the second scanning signal and the light-emitting control signal to be high level signals; controlling the fifth transistor and the sixth transistor to be off by the light-emitting control signal; and controlling the seventh transistor to turn on by the first scanning signal.

9. The driving method of claim 8, wherein in the storing phase, the driving method further comprising: controlling the fifth transistor to be off by the light-emitting control signal; controlling the second transistor to turn on by the second scanning signal; and a potential of the first electrode of the first transistor being equal to the data voltage;
a potential of the control terminal of the first transistor being equal to V_{data}−|Vₜₕ|, wherein V_{data} is the data voltage, |Vₜₕ| is an absolute value of a threshold voltage of the first transistor.

10. The driving method of claim 9, wherein in the light emitting phase, the driving method further comprising: controlling the fifth transistor to turn on by the light-emitting control signal; controlling the fourth transistor to be off by the first scanning signal; and controlling the third transistor to be off by the second scanning signal; the potential of the first electrode of the first transistor being equal to the first voltage supply;
the potential of the control terminal of the first transistor being equal to V_{data}−|Vₜₕ|+η(V_{DD}−V_{data});
wherein η is a voltage division ratio coefficient determined by a capacitance of the first capacitor and a capacitance of a second capacitor, and a sum of the capacitance of the second capacitor and the capacitance of the first capacitor is an overall capacitance at the control terminal of the first transistor.
